(19) United States
(12) Patent Application Publication
(10) Pub. No.: US 2020/0111104 A1
(43) Pub. Date: Apr. 9, 2020

(54) SECURING A CUSTOMER HISTORY IN A CONTACT CENTER

(71) Applicant: Avaya Inc., Santa Clara, CA (US)

(72) Inventors: Jibin George, Pune (IN); Salil Dhawan, Pune (IN); Sandeep Goynar, Pune (IN); Harsimran Jeet Singh, Pune (IN)

(21) Appl. No.: 16/152,683

(22) Filed: Oct. 5, 2018

(51) Int. Cl. G06Q 30/00; G06F 17/30; G06F 21/62

(52) U.S. Cl. CPC G06Q 30/01; G06F 21/6245; G06F 17/30345; G06F 17/30283

(57) ABSTRACT

Embodiments of the disclosure provide for managing a change in contact information associated with that user and securing a customer history after the change in contact information associated with that user. Services within a peer-to-peer network can share a distributed secure ledger. This distributed secure ledger can comprise information associated contact information, such as a phone number, with a user and indicate its status as activated or deactivated. Once any member of the peer-to-peer network, such a telecommunications service provider, detects a change, e.g., a user obtaining a new cellphone number or relinquishing an old one, that peer can update the secure distributed ledger and notify the other members of the peer-to-peer network. In this way, all members can be informed and updated as the change occurs and can then take action to locally associate or disassociate that user with that contact information, archive any past customer records, etc.

### FIELD OF THE DISCLOSURE

Embodiments of the present disclosure relate generally to methods and systems for securing customer history information in a contact center and more particularly to securing the customer history after a change in contact information associated with that user.

### BACKGROUND

A contact center is a set of system and services for interacting with customers and/or potential customers of a business entity. For example, a typical contact center allows users to communicate via different channels such as voice calls, video messages, text messages, emails, instant messages, etc., with any of a variety of different resources of the contact center such as human agents, chatbots, online libraries, etc. In many cases, these users are identified by the contact center by some identifying information related to a channel though which they have made contact, e.g., a phone number, email address, IM username, etc. However, such information is subject to change from time to time such as, for example, when the user changes phone numbers, discontinues use of a certain email account, creates a new or changes usernames, etc.

In current contact centers, when such contact information changes, problems can occur. For example, many contact centers maintain a history of interactions with a customer identified by or associated with the contact information and which remains mapped to the old, discontinued number. In current systems, there is no action taken by the contact center to disassociate the customer history information with the old or discontinued contact information. If the old contact information is allocated to a new customer, which is especially common with phone numbers but can occur with other types of contact information as well, there is a mismatch between the actual customer calling a contact center and the customer history associated with that number. So, if the new customer calls from that reallocated number, the contact center uses the old customer history associated with that contact information while answering the call from the new customer. This can result in a security problem since older customer history is at risk to be exposed to a different customer. Additionally, the wrong customer history is made available to the contact center resource, e.g., shown to the contact center agent, which results in a mismatch between the customers inquiry and the results delivered, thereby decreasing customer satisfaction. Currently, the disassociation between the customer history and the contact information needs to be done manually by the agent on an individual contact center basis once the mismatch is detected. Hence, there is a need for improved methods and systems for managing a change in contact information associated with a user.

### BRIEF SUMMARY

Embodiments of the disclosure provide systems and methods for managing a change in contact information associated with that user and securing a customer history after the change in contact information associated with that user. Generally speaking, services within a peer-to-peer network can share a distributed secure ledger. This distributed secure ledger can comprise information associated contact information, such as a phone number, email address, username, etc., with a user and indicate its status as activated or deactivated. Once any member of the peer-to-peer network, such a telecommunications service provider, detects a change, e.g., a user obtaining a new cellphone number or relinquishing an old one, that peer can update the secure distributed ledger and notify the other members of the peer-to-peer network. In this way, all members can be informed and updated as the change occurs and can then take action to locally associate or disassociate that user with that contact information, archive any past customer records, etc.

According to one embodiment, a system can comprise a first server of a plurality of servers communicatively coupled in a peer-to-peer network. The first server can provide a first service to a user of a plurality of user. The first server can comprise a processor and a memory coupled with and readable by the processor and storing therein a set of instructions which, when executed by the processor of the first server, causes the first server to receive an update for contact information associated with the user. The contact information can be used by at least one of servers of the plurality of servers to uniquely identify the user. In some cases, the instructions executed by the processor of the first server can further cause the first server to confirm the update for the contact information with the user. Additionally, or alternatively, the instructions executed by the processor of the first server can further cause the first server to confirm the update for the contact information with a server providing a verification service. For example, the verification service can be provided by a governmental entity.

The instructions executed by the processor of the first server can further cause the first server to update a distributed secure ledger based on the received update for the contact information associated with the user. The distributed secure ledger can comprise a plurality of entries, each entry storing identity information for a user of the plurality of users. For example, each entry in the distributed secure ledger can comprise a customer name for the user, the contact information, and a status indicator. The contact information can comprise a phone number and the status indicator indicating activated or deactivated. In some cases, the distributed secure ledger can comprise a block chain. The instructions executed by the processor of the first server can then cause the first server to send to each other server of the plurality of servers a notification that the distributed secure ledger has been updated.

A second server of the plurality of servers providing a second service to the user can comprise a processor and a memory coupled with and readable by the processor and storing therein a set of instructions which, when executed by the processor of the second server, causes the second server to receive, from the first server, the notification that the distributed secure ledger has been updated and determine whether the distributed secure ledger has been updated to remove the contact information for the user or add contact information for the user. In response to determining the distributed secure ledger has been updated to remove the contact information for the user, the instructions executed by the processor of the second server can cause the second server to disassociate the contact information from the user in the second service. In response to determining the distributed secure ledger has been updated to add the contact information for the user, the instructions executed by the processor of the second server can cause the second server to associate the contact information with the user in the second service. In some cases, the second service can comprise, for example, a telecommunication service. The instructions executed by the processor of the second server can, in some cases, further cause the second server to archive a customer history for the user associated with contact information.

According to another embodiment, a method for managing a change in contact information associated with a user can comprise receiving, by a server providing a service to a plurality of users, an update for contact information associated with a user of the plurality of users. The contact information can be used by at least one server of a plurality of servers in a peer-to-peer network to uniquely identify the user. In some cases, the server can confirm the update for the contact information with the user. Additionally, or alternatively, the server can confirm the update for the contact information with a server providing a verification service before updating the secure ledger. For example, the verification service can be provided by a governmental entity.

After the update is received and perhaps confirmed, the server can update a distributed secure ledger based on the received update for the contact information associated with the user. The distributed secure ledger can comprise a plurality of entries, each entry storing identity information for a user of the plurality of users. For example, each entry in the distributed secure ledger can comprise a customer name for the user, the contact information, and a status indicator. In one implementation, the contact information can comprise a phone number, the status indicator can indicate activated or deactivated, and the distributed secure ledger can comprise a block chain. The server can then send a notification to each other server of the plurality of servers indicating that the distributed secure ledger has been updated.

According to another embodiment, a method for securing a customer history after a change in contact information associated with that user can comprise receiving, by a first server, a notification from a second server in a peer-to-peer network with the first server, that contact information for the user has been updated. The contact information can be used by the first server to identify the user. For example, the contact information can comprise a phone number and the first server may provide a telecommunication service to the user. The contact information can be stored in a distributed secure ledger by the first server. Each entry in the distributed secure ledger can comprise, for example, a customer name for the user, the contact information, and a status indicator. The status indicator can indicate activated or deactivated. In some cases, the distributed secure ledger can comprise a block chain.

The first server can then determine whether the distributed secure ledger has been updated to remove the contact information for the user or add contact information for the user. In response to determining the distributed secure ledger has been updated to remove the contact information for the user, the contact information can be disassociated from the user in the first server. A customer history for the user associated with contact information ca also be archived. In response to determining the distributed secure ledger has been updated to add the contact information for the user, the contact information can be associated with the user in the second service.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating elements of an exemplary system for managing a change in contact information associated with that user and securing a customer history after the change in contact information associated with that user according to one embodiment of the present disclosure.

FIG. 4 is a flowchart illustrating an exemplary process for managing a change in contact information associated with that user and securing a customer history after the change in contact information associated with that user according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

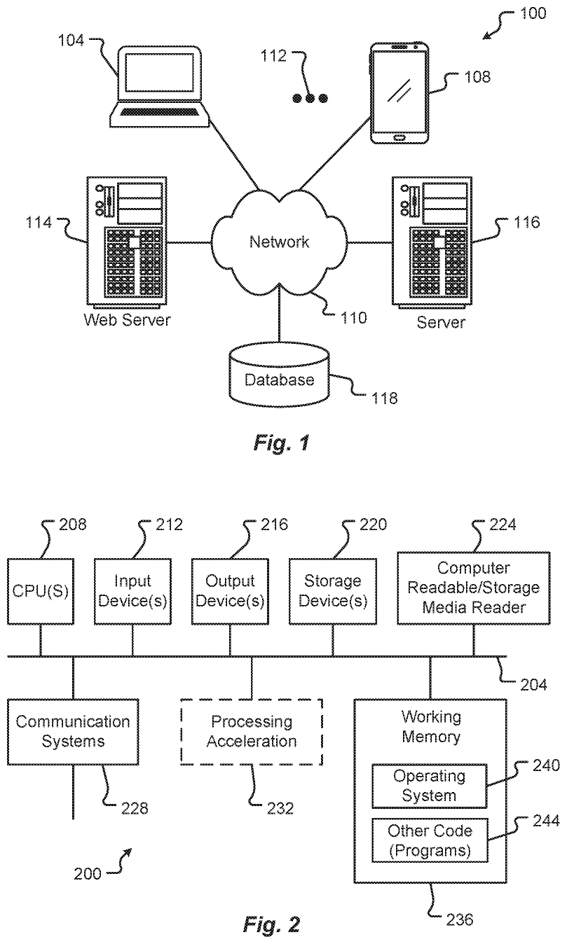

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

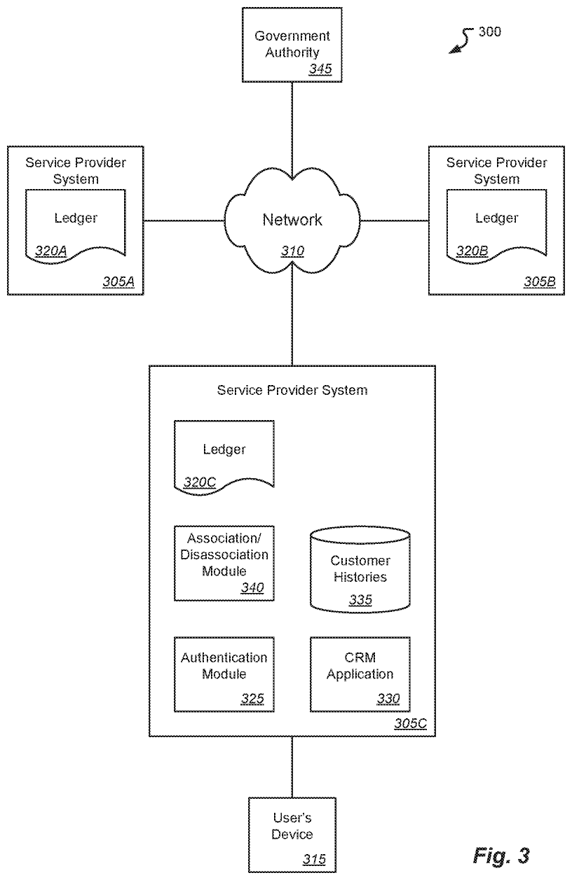

FIG. 3 is a block diagram illustrating elements of an exemplary system for managing a change in contact information associated with that user and securing a customer history after the change in contact information associated with that user according to one embodiment of the present disclosure. As illustrated in this example, the system 300 can comprise a set of service provider systems 305A-305C communicatively coupled via a communications network 310. Each service provider system 305A-305C can comprise one or more servers and/or other computing systems or devices as described above. The network 310 can comprise any one or more wired and/or wireless, local and/or wide area networks also as described above. Services provided by the servers can comprise, for example, wired and/or wireless telecommunication services, customer relations management, i.e., customer contact center, services, etc.

Embodiments of the disclosure provide managing a change in contact information associated with user and securing a customer history after the change in contact information associated with that user. For example, a user may change telephone numbers, email addresses, IM user names, social media user names, or other similar identifying information. For services that identify the user by that contact information, these changes should be detected and handled promptly to avoid potentially misidentifying users with the discontinued contact information or, potentially worse, misidentifying a different user once the contact information is reassigned or reallocated.

Generally speaking, each service provider system 305A-305C within a peer-to-peer network can share a distributed secure ledger 320A-320C. This distributed secure ledger 320A-320C can comprise a plurality of records, each record comprising contact information, such as a phone number, email address, username, etc., associated with a user and can indicate its status as activated or deactivated. Once any member of the peer-to-peer network, such a telecommunications service provider 305A, detects a change, e.g., a user obtaining a new cellphone number or relinquishing an old one, that peer can update the secure distributed ledger 305A-305C and notify the other service providers 305B and 605C that are members of the peer-to-peer network. In this way, all members can be informed and updated as the change occurs and can then take action to locally associate or disassociate that user with that contact information, archive any past customer records, etc.

According to one embodiment, a first server or service provider system 305A can be communicatively coupled in a peer-to-peer network with other service provider systems 305B and 305C. The first server c or service provider system 305A an provide a first service to a user of a plurality of user such as a wireless communications or other telecommunications service, for example. The first server or service provider system 305A can receive an update for contact information associated with the user, such as when the user obtains a new phone number, relinquishes an old one, or both. The contact information can be used by other members of the peer to peer network such as service provider system 305B and/or service provider system 305C to uniquely identify the user. In some cases, the instructions executed by the processor of the first server or service provider system 305A can further cause the first server or service provider system 305A to confirm the update for the contact information with the user. For example, the or service provider system 305A can send an inquiry or other message to the user using the contact information or an alternative identified by the user upon registration or issuance of the contact information. Additionally, or alternatively, the instructions executed by the processor of the first server or service provider system 305A can further cause the first server or service provider system 305A to confirm the update for the contact information with a server providing a verification service 345. For example, the verification service can be provided by a governmental entity 345 regulating issuance of contact information such as phone numbers.

The first server or service provider system 305A can further update a distributed secure ledger 320A-320C based on the received update for the contact information associated with the user. The distributed secure ledger 320A-320C can comprise a plurality of entries, each entry storing identity information for a user of the plurality of users. For example, each entry in the distributed secure ledger 320A-320C can comprise a customer name for the user, the contact information, and a status indicator. The contact information can comprise a phone number, email address, IM user name, etc., and the status indicator can indicate the contact information as either activated or deactivated. In some cases, the distributed secure ledger 320A-320C can comprise a block chain. The first server can then cause the first server or service provider system 305A to send to each other server of the plurality of servers or service provider systems 305B and 305C a notification that the distributed secure ledger 320A-320C has been updated.

A second server or service provider system 305C providing a second service to the user can comprise, for example, a contact center system executing a Customer Relationship Management (CRM) or similar application 330 to users contacting the system through a user device 315 such as a cell phone, for example. When contacting the user device 315 connects with the service provider system 305C, an authentication module 325 can authenticate the user of the user device 315 using the contact information and/or other information such as credentials provided by the user or user device 315, biometric information from the user provided through the device 315, secret information such as a password etc. provided by the user through the device 315 etc. Once authenticated, the user can be serviced by the CRM application 330 which can use the contact information to locate and utilize customer history information 335, e.g., a record of past interactions with the CRM application 330.

In the case that this user change contact information, e.g., purchases a new user device 315 or otherwise changes phone numbers, email addresses, etc., the or service provider system 305C can receive the notification that the distributed secure ledger 320A-320C has been updated and can determine, through an association/disassociation module 340 whether the distributed secure ledger 320A-320C has been updated to remove the contact information for the user or add contact information for the user. In response to determining the distributed secure ledger 320A-320C has been updated to remove the contact information for the user, the association/disassociation module 340 of the service provider system 305C can disassociate the contact information from the user in the second service or service provider system 305C. In response to determining the distributed secure ledger 320A-320C has been updated to add the contact information for the user, association/disassociation module 340 of the service provider system 305C can associate the contact information with the user in the second service. In the case that the user has changed numbers, the notifications may indicate, and the association/disassociation module 340 of the service provider system 305C may be perform both, i.e., disassociating with the old contact information and associating with the new. In some cases, service provider system 305C may also archive a customer history for the user associated with contact information.

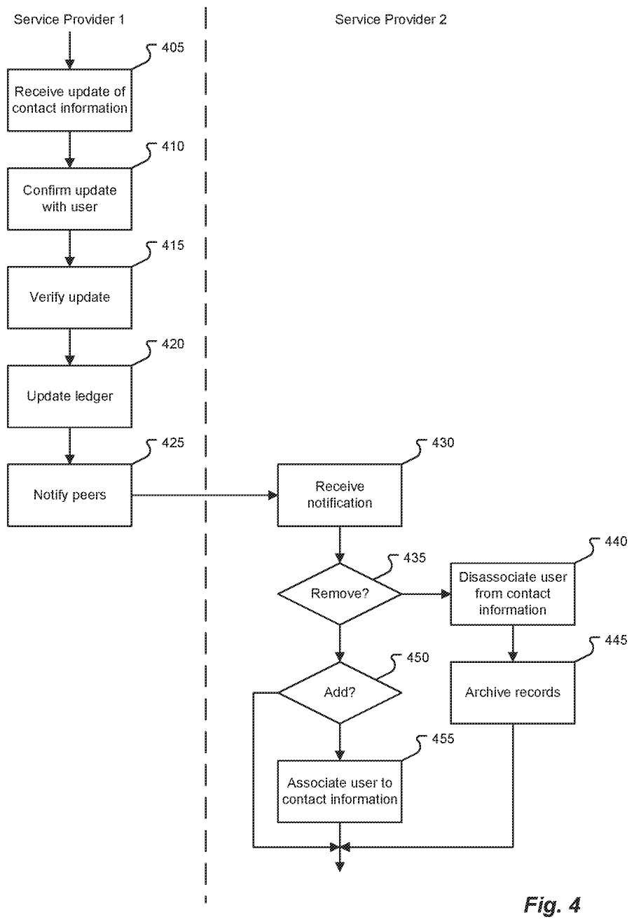

FIG. 4 is a flowchart illustrating an exemplary process for managing a change in contact information associated with that user and securing a customer history after the change in contact information associated with that user according to one embodiment of the present disclosure. As illustrated in this example, managing a change in contact information associated with a user can comprise receiving 405, by a server providing a service to a plurality of users, an update for contact information associated with a user of the plurality of users. The contact information can be used by at least one server of a plurality of servers in a peer-to-peer network to uniquely identify the user. In some cases, the server can confirm 410 the update for the contact information with the user. Additionally, or alternatively, the server can confirm or verify 415 the update for the contact information with a server providing a verification service before updating the secure ledger. For example, the verification service can be provided by a governmental entity.

After the update is received 405 and perhaps confirmed 410 and 415, the server can update 420 a distributed secure ledger based on the received update for the contact information associated with the user. The distributed secure ledger can comprise a plurality of entries, each entry storing identity information for a user of the plurality of users. For example, each entry in the distributed secure ledger can comprise a customer name for the user, the contact information, and a status indicator. In one implementation, the contact information can comprise a phone number, the status indicator can indicate activated or deactivated, and the distributed secure ledger can comprise a block chain. The server can then send a notification 425 to each other server of the plurality of servers indicating that the distributed secure ledger has been updated.

Securing a customer history after a change in contact information associated with that user can comprise receiving 430, by another server in the peer-to-peer network, the notification that contact information for the user has been updated. The server can then determine 435 whether the distributed secure ledger has been updated to remove the contact information for the user. In response to determining 435 the distributed secure ledger has been updated to remove the contact information for the user, the contact information can be disassociated 440 from the user in the server. A customer history for the user associated with contact information ca also be archived 445. The server can additionally or alternatively determine 450 whether the distributed secure ledger has been updated to add contact information for the user. In response to determining 450 the distributed secure ledger has been updated to add the contact information for the user, the contact information can be associated 455 with the user in the second service.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a first server of a plurality of servers communicatively coupled in a peer-to-peer network, the first server providing a first service to a user of a plurality of user and comprising a processor and a memory coupled with and readable by the processor and storing therein a set of instructions which, when executed by the processor of the first server, causes the first server to:
receive an update for contact information associated with the user, wherein the contact information used by at least one server of the plurality of servers to uniquely identify the user,
update a distributed secure ledger based on the received update for the contact information associated with the user, the distributed secure ledger comprising a plurality of entries, each entry storing identity information for a user of the plurality of users, and
sending, to each other server of the plurality of servers, a notification that the distributed secure ledger has been updated; and
a second server of the plurality of servers providing a second service to the user and comprising a processor and a memory coupled with and readable by the processor and storing therein a set of instructions which, when executed by the processor of the second server, causes the second server to:
receive, from the first server, the notification that the distributed secure ledger has been updated,
determine whether the distributed secure ledger has been updated to remove the contact information for the user or add contact information for the user,
in response to determining the distributed secure ledger has been updated to remove the contact information for the user, disassociated the contact information from the user in the second service, and
in response to determining the distributed secure ledger has been updated to add the contact information for the user, associating the contact information with the user in the second service.

2. The system of claim 1, wherein the instructions executed by the processor of the first server further cause the first server to confirm the update for the contact information with the user before updating the distributed secure ledger.

3. The system of claim 1, wherein the instructions executed by the processor of the first server further cause the first server to confirm the update for the contact information with a server providing a verification service before updating the secure ledger.

4. The system of claim 3, wherein the verification service is provided by a governmental entity.

5. The system of claim 1, wherein the instructions executed by the processor of the second server further cause the second server to archive a customer history for the user associated with contact information.

6. The system of claim 1, wherein each entry in the distributed secure ledger comprises a customer name for the user, the contact information, and a status indicator, the status indicator indicating activated or deactivated.

7. The system of claim 6, wherein the distributed secure ledger comprises a block chain.

8. The system of claim 1, wherein the contact information comprises a phone number.

9. The system of claim 8, wherein the second service comprises a telecommunication service.

10. A method for managing a change in contact information associated with that user, the method comprising:
receiving, by a server providing a service to a plurality of users, an update for contact information associated with a user of the plurality of users, wherein the contact information is used by at least one server of a plurality of servers in a peer-to-peer network to uniquely identify the user;
updating, by the server, a distributed secure ledger based on the received update for the contact information associated with the user, the distributed secure ledger comprising a plurality of entries, each entry storing identity information for a user of the plurality of users; and
sending, by the server to each other server of the plurality of servers, a notification that the distributed secure ledger has been updated.

11. The method of claim 10, further comprising confirming, by the server, the update for the contact information with the user before updating the distributed secure ledger.

12. The method of claim 10, further comprising confirming, by the server, the update for the contact information with a server providing a verification service before updating the secure ledger.

13. The method of claim 12, wherein the verification service is provided by a governmental entity.

14. The method of claim 10, wherein each entry in the distributed secure ledger comprises a customer name for the user, the contact information, and a status indicator, the status indicator indicating activated or deactivated and wherein the distributed secure ledger comprises a block chain.

15. A method for securing the customer history after a change in contact information associated with that user, the method comprising:
receiving, by a first server, a notification from a second server in a peer-to-peer network with the first server, that contact information for a user has been updated, wherein the contact information is used by the first server to identify the user and wherein the contact information is stored in a distributed secure ledger;
determining, by the first server, whether the distributed secure ledger has been updated to remove the contact information for the user or add contact information for the user,
in response to determining the distributed secure ledger has been updated to remove the contact information for the user, disassociating, by the first server, the contact information from the user in the first server, and
in response to determining the distributed secure ledger has been updated to add the contact information for the user, associating the contact information with the user in the second service.

16. The method of claim 15, further comprising archiving a customer history for the user associated with contact information.

17. The method of claim 15, wherein each entry in the distributed secure ledger comprises a customer name for the user, the contact information, and a status indicator, the status indicator indicating activated or deactivated.

18. The method of claim 17, wherein the distributed secure ledger comprises a block chain.

19. The method of claim 15, wherein the contact information comprises a phone number.

20. The method of claim 19, wherein the first server provides a telecommunication service to the user.
